(19) United States
(12) Patent Application Publication
(10) Pub. No.: US 2017/0211686 A1
(43) Pub. Date: Jul. 27, 2017

(54) COMBINED HEAT STORAGE AND PRESSURE STORAGE ACCUMULATOR

(71) Applicant: BorgWarner Inc., Auburn Hills, MI (US)

(72) Inventors: Christopher A. SPANGLER, Rochester Hills, MI (US); Christopher E. BLAIR, Fenton, MI (US); Chengyun GUO, Novi, MI (US)

(73) Assignee: BorgWarner Inc., Auburn Hills, MI (US)

(21) Appl. No.: 15/328,912

(22) PCT Filed: Jul. 16, 2015
(86) PCT No.: PCT/US2015/040679

§ 371 Date: Jan. 25, 2017

Related U.S. Application Data
(60) Provisional application No. 62/030,327, filed on Jul. 29, 2014.

(51) Int. Cl. F16H 57/04; F15B 1/04; F02N 19/04; F16H 61/00

(52) U.S. Cl. CPC F16H 57/0419; F16H 61/0021; F15B 1/04; F02N 19/04; F16H 2061/0034; F16H 2312/20

(57) ABSTRACT

A number of variations include an accumulator constructed and arranged to store pressurized hydraulic fluid and a thermal containment device surrounding at least a portion of the accumulator constructed and arranged to reduce the loss of heat from hydraulic fluid stored in the accumulator.

### CROSS-REFERENCE TO RELATED APPLICATIONS

This application claims the benefit of U.S. Provisional Application No. 62/030,327 filed Jul. 29, 2014.

### TECHNICAL FIELD

The field to which the disclosure generally relates to includes combined heat storage and pressure storage accumulators.

### BACKGROUND

Vehicles may include devices such as, but not limited to, transmissions and/or engines which utilize hydraulic fluids.

### SUMMARY OF ILLUSTRATIVE VARIATIONS

A number of variations include an accumulator constructed and arranged to store pressurized hydraulic fluid and a thermal containment device surrounding at least a portion of the accumulator constructed and arranged to reduce the loss of heat from hydraulic fluid stored in the accumulator.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 is a schematic illustration of a product including an accumulator constructed and arranged to store pressurized hydraulic fluid and a thermal containment device surrounding at least the portion of the accumulator according to a number of variations.

FIG. 2 is a schematic illustration of a section of a product including an accumulator constructed and arranged to store pressurized hydraulic fluid and a thermal containment device surrounding a portion of the accumulator and wherein the thermal containment device includes an insulator according to a number of variations.

FIG. 3 is a schematic illustration of a section of a product including an accumulator constructed and arranged to store pressurized hydraulic fluid and a thermal containment device surrounding a portion of the accumulator, and wherein the thermal containment device includes an insulating fluid according to a number of variations.

FIG. 4 is a graph illustrating the effect of using an accumulator constructed and arranged to store pressurized hydraulic fluid and having a thermal containment device surrounding a portion of the accumulator which may result in an increase in the initial oil temperature of transmission oil operated across an entire warm up phase according to a number of variations.

### DETAILED DESCRIPTION OF ILLUSTRATIVE VARIATIONS

The following description of the variations is merely illustrative in nature and is in no way intended to limit the scope of the invention, its application, or uses.

FIG. 1 illustrates a number of variations which may include a product 10 that may include an accumulator 11 having an outer housing 12 carrying an accumulator mechanism 14. The accumulator mechanism 14 may be any of a variety of types and may be constructed and arranged to store pressurized hydraulic fluid such as, but not limited to, transmission oil. The accumulator mechanism 14 may include a chamber having a piston received in the chamber for sliding movement therein with the piston being biased by a force, for example, from a spring or other suitable mechanism. The product 10 may also include a thermal containment device 16 which may include an outer shell 18 spaced the housing 12 of the accumulator 11. An insulating void 20 may be defined between the outer shell 18 and the housing 12. In a number of variations, the insulating void may be the void of any material, such as being under a vacuum, may include an insulating gas, an insulating liquid, or an insulating material including a solid structure or structures.

Referring now to FIG. 2, in a number of variations, the insulating void 20 may be filled with a material having at least one solid structure such as a plurality of fibers bound together. In a number of variations, the insulating void 20 may be filled with glass fibers bound together by a polymeric binder. The fibers 22 may be randomly formed or may be in form of a weave and may provide a plurality of pockets wherein air may reside and reduce the thermal transfer of heat from hydraulic fluid stored in the accumulator mechanism 14.

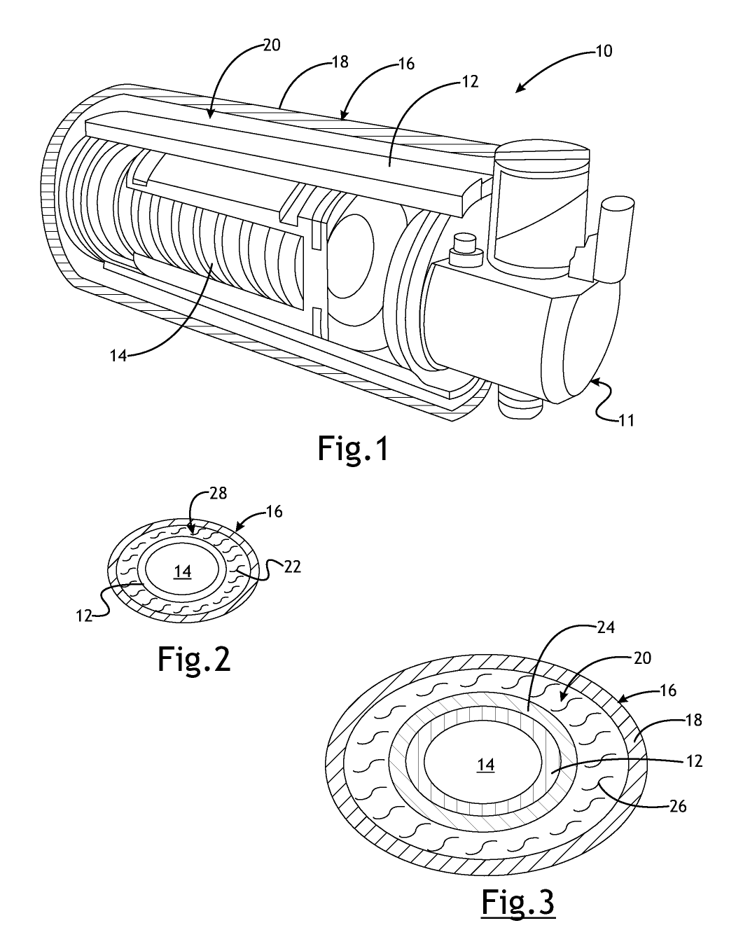

Referring now to FIG. 3, in a number of other variations, the thermal containment device 16 may also include an inner shell 24 spaced apart from the outer shell 18. An insulating fluid 26, such as an insulating liquid, may be received in the insulating void 20 formed between the outer shell 18 and the inner shell 24.

A vehicle is typically started after a long period of time which may be several hours or even overnight wherein the engine has not been running and the transmission oil in the vehicle is close to the ambient temperature. Time is required to heat a typical transmission fluid (oil) during operation. The viscosity of the transmission fluid is directly related to its temperature. As the temperature of the transmission fluid increases the viscosity decreases resulting in an increase in the transmission efficiency.

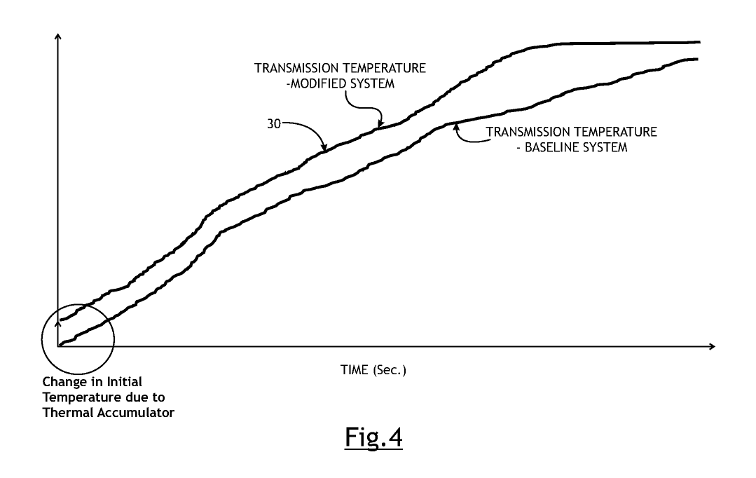

Referring now to FIG. 4, an increase in the initial oil temperature (as shown by arrow in FIG. 4), results in higher transmission operating temperatures across the entire warm up phase (shown by the solid line 30). The increase in transmission operating temperature across the driving cycle results in improved transmission efficiency, improved fuel consumption and reduced carbon dioxide emissions without compromising the current ability of the accumulator to provide oil during a stop-start event. According to a number of variations, a method may include providing an accumulator constructed and arranged to store pressurized hydraulic fluid and having a thermal containment device surrounding a portion of the accumulator. During operation, transmission oil is pumped into the accumulator 11 and stored in a pressurized and warm state. Upon restart of the vehicle engine, warm hydraulic fluid from the accumulator 11 is released through a control valve and back into the transmission to increase the starting temperature of the transmission oil. In other variations the hydraulic fluid may be released from the accumulator into any of a variety of vehicle components including at least one of a combustion engine, transfer case, axle housings or any other vehicle component utilizing a hydraulic fluid.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: an accumulator having an outer housing carrying an accumulator mechanism, and a thermal containment device comprising an outer shell spaced away from the housing of the accumulator.

Variation 2 may include a product as set forth in Variation 1 wherein an insulating space may be defined between the outer shell and the housing.

Variation 3 may include a product as set forth in Variation 2 wherein the insulating space is under vacuum.

Variation 4 may include a product as set forth in any of Variations 2-3 further comprising an insulating gas in the insulating space.

Variation 5 may include a product as set forth in any of Variations 2-4 further comprising an insulating liquid in the insulating space.

Variation 6 may include a product as set forth in any of Variations 2-5 further comprising an insulating material foam or solid particles in the insulating space.

Variation 7 may include a product as set forth in any of Variations 2-6 further comprising an insulating material including at least one a solid structure in the insulating space.

Variation 8 may include a product as set forth in Variation 7 wherein the at least one a solid structure comprises a plurality of fibers bound together.

Variation 9 may include a product as set forth in Variation 7 wherein the at least one a solid structure comprises carbon dust.

Variation 10 may include a product comprising an accumulator constructed and arranged to store pressurized hydraulic fluid and a thermal containment device surrounding at least a portion of the accumulator constructed and arranged to reduce the loss of heat from hydraulic fluid stored in the accumulator

Variation 11 may include a method comprising: a vehicle, a vehicle component, hydraulic fluid, and an accumulator constructed and arranged to store pressurized hydraulic fluid and having a thermal containment device surrounding a portion of the accumulator; operating the vehicle so that the vehicle component warms the hydraulic fluid; and pumping warm hydraulic fluid into the accumulator and storing at least a portion of the warm hydraulic fluid in the accumulator in a pressurized and warm state; shutting down the vehicle; thereafter starting the vehicle, and releasing warm hydraulic fluid from the accumulator into the vehicle component.

Variation 12 may include a product as set forth in Variation 11 wherein the vehicle component is a transmission.

Variation 13 may include a product as set forth in Variation 11 wherein the vehicle component is a combustion engine. The above description of select variations within the scope of the invention is merely illustrative in nature and, thus, variations or variants thereof are not to be regarded as a departure from the spirit and scope of the invention.

What is claimed is:

1. A product comprising:
an accumulator having an outer housing carrying an accumulator mechanism, and a thermal containment device comprising an outer shell spaced away the housing of the accumulator.

2. A product as set forth in claim 1 wherein an insulating space is defined between the outer shell and the housing.

3. A product as set forth in claim 2 wherein the insulating space is under vacuum.

4. A product as set forth in claim 2 further comprising an insulating gas in the insulating space.

5. A product as set forth in claim 2 further comprising an insulating liquid in the insulating space.

6. A product as set forth in claim 2 further comprising a foam or solid particles in the insulating space.

7. A product as set forth in claim 2 further comprising an insulating material including at least one a solid structure in the insulating space.

8. A product as set forth in claim 7 wherein the at least one a solid structure comprises a plurality of fibers bound together.

9. A product as set forth in claim 7 wherein the at least one solid structure comprises carbon dust.

10. A product comprising an accumulator constructed and arranged to store pressurized hydraulic fluid and a thermal containment device surrounding at least a portion of the accumulator constructed and arranged to reduce the loss of heat from hydraulic fluid stored in the accumulator.

11. A method comprising:
providing a vehicle, a vehicle component, hydraulic fluid, and an accumulator constructed and arranged to store pressurized hydraulic fluid and having a thermal containment device surrounding a portion of the accumulator;
operating the vehicle so that the vehicle component warms the hydraulic fluid;
and pumping warm hydraulic fluid into the accumulator and storing at least a portion of the warm hydraulic fluid in the accumulator in a pressurized and warm state;
shutting down the vehicle;
thereafter starting the vehicle, and releasing warm hydraulic fluid from the accumulator 11 into the vehicle component.

12. A method as set forth in claim 11 wherein the vehicle component is a transmission.

13. A method as set forth in claim 11 wherein the vehicle component is a combustion engine.

14. A method as set forth in claim 11 wherein the vehicle component at least one of a combustion engine, transfer case, or axle housing.
